(19) United States
(12) Patent Application Publication
(10) Pub. No.: US 2024/0315481 A1
(43) Pub. Date: Sep. 26, 2024

(54) Beverage Dispensing Machine

(71) Applicant: SEB S.A., Ecully (FR)

(72) Inventors: Annabelle Guillot, Ecully Cedex (FR); Alban Pfersdorff, Ecully Cedex (FR); Alban Vetillard, Ecully Cedex (FR)

(73) Assignee: SEB S.A., Ecully (FR)

(21) Appl. No.: 18/613,840

(22) Filed: Mar. 22, 2024

(30) Foreign Application Priority Data
Mar. 23, 2023 (FR) 2302731

(51) Int. Cl. A47J 31/44; A47J 31/46

(52) U.S. Cl. CPC A47J 31/4482; A47J 31/46

(57) ABSTRACT

A beverage dispensing machine includes a beverage dispensing head whose position relative to a container receiving area can be adjusted, and a receiving structure for the dispensing head having a first slide and a second slide designed to interact with a respective lateral side of the dispensing head to form a first slide connection and a second slide connection, respectively. The receiving structure also includes a third slide, positioned between the first and second slides and designed to interact with the dispensing head to form a third slide connection. The third slide is closer to the receiving area along the longitudinal axis than the first slide and the second slide.

### TECHNICAL FIELD

The present invention relates to the field of beverage dispensing machines, and in particular coffee machines, comprising an area for receiving a container and a beverage dispensing head whose position relative to the receiving area is adjustable in height between a high position and a low position.

### STATE OF THE ART

CN105326397 discloses a coffee machine equipped with a coffee dispensing head whose height relative to the container receiving area is adjustable. The height of the dispensing head can be adjusted via two slide connections formed between the dispensing head and the coffee machine frame. The dispensing head also comprises axial stops designed to cooperate with frame components to limit the height adjustment range of the dispensing head.

Such a coffee machine makes it easy to adapt the height of the dispensing head to the height of the container.

However, in such a machine, the dispensing head is not solidly attached to the frame, especially when in the low position. In fact, there is a risk that when handling the dispensing head, it may pivot and/or tilt and/or derail. Moreover, the potential height adjustment range of the dispensing head is reduced. In fact, the distance between the axial stops and the frame components designed to cooperate with said stops to limit the height adjustment range of the dispensing head is reduced.

### SUMMARY OF THE INVENTION

This invention is intended to remedy these disadvantages.

The technical problem behind the invention is to provide a beverage dispensing machine featuring a height-adjustable beverage dispensing head with improved frame attachment and improved height-adjustment range.

To this end, the invention relates to a beverage dispensing machine comprising:
a frame suitable for receiving a beverage preparation unit and defining a container receiving area; and
a beverage dispensing head whose position relative to the receiving area along a longitudinal axis of travel of the dispensing head can be adjusted between a high position and a low position,
   the frame comprising a dispensing head receiving structure comprising a first slide and a second slide designed to interact with a respective lateral side of the dispensing head to form a first slide connection and a second slide connection, respectively.

In accordance with the invention, the receiving structure also comprises a third slide, positioned between the first and second slides along a transverse axis substantially perpendicular to the longitudinal axis, the third slide being designed to interact with the dispensing head to form a third slide connection, the third slide being closer to the receiving area along the longitudinal axis than the first and second slides.

The invention improves the dispensing head attachment and adjustment range. In fact, the third slide makes it possible to achieve an optimized attachment relative to a two-slide solution. Furthermore, the positioning of the third slide ensures efficient attachment even when the dispensing head is in the low position. This thus reduces the risk of the dispensing head swiveling and/or tilting and/or derailing. In addition, the third slide makes it possible to achieve an optimized height adjustment range, particularly due to its position relative to the first and second slides. As a result, the beverage dispensing machine is suited to a wider range of container heights and the user experience is enhanced. Lastly, such an arrangement also frees up the receiving area to a maximum extent, in particular to accommodate a large container.

According to advantageous but non-mandatory aspects of the invention, such a beverage dispensing machine can incorporate one or more of the following features, taken in any technically permissible combination.

According to an advantageous feature of the invention, the dispensing head comprises:
on a first lateral side, a first engagement relief for the first slide, the first engagement relief and the first slide forming the first slide connection,
on a second lateral side, a second engagement relief on the second slide, the second engagement relief and the second slide forming the second slide connection, and
on a central part, a third engagement relief on the third slide, the third engagement relief and the third slide forming the third slide connection.

Such an arrangement ensures that the dispensing head is attached to the slides so that it can move along the longitudinal axis.

According to an advantageous feature of the invention, the first, second and third engagement reliefs are formed by grooves that preferentially have a U-shaped cross-section, and the first, second and third slides comprise ribs designed to be received in the corresponding grooves.

Such an arrangement ensures that the dispensing head is held in place and slides optimally relative to the frame.

According to an advantageous feature of the invention, the dispensing head comprises a beverage dispensing body defining at least one beverage flow channel and advantageously provided with two beverage outlets, the dispensing body also comprising the first, second and third engagement reliefs, and the dispensing head comprises a member for adjusting the position of the dispensing head relative to the receiving area along the longitudinal axis, the adjustment member being designed to be attached to the dispensing body and comprising a gripping area designed to be grasped by a user so that the user can adjust the position of the dispensing head between the high and low positions.

Such an arrangement makes it possible to have two different parts to ensure, respectively, beverage dispensing, translation of the dispensing head and user adjustment of the position of the dispensing head. The design and material of each part can thus be optimized according to its function.

According to an advantageous feature of the invention, the receiving structure comprises a front wall and a rear wall delimiting a space for receiving the dispensing head, the adjustment member comprises at least one member for creating friction against the front wall and for each friction member the dispensing head comprises a component for retaining the dispensing body in position along the longitudinal axis, each retaining component being designed to exert a retaining force on the corresponding friction member to keep the friction member in contact with the front wall.

Such an arrangement makes it easy to adjust the position of the dispensing head relative to the receiving area over time and enables the dispensing head to be locked in the position set by the user using the adjustment member.

According to an advantageous feature of the invention, the receiving structure comprises a front wall and a rear wall delimiting a space for receiving the dispensing head, the first, second and third slides extending from the rear wall.

Such a configuration makes it easier to incorporate the dispensing head into the frame and to provide an outer casing for the dispensing head, in particular for a functional part of the dispensing head.

According to an advantageous feature of the invention, the third slide extends perpendicular to the rear wall and the first and second slides extend parallel to the rear wall.

Such an arrangement makes it possible to minimize the size of the dispensing head and to free up the receiving area to a maximum extent, in particular to accommodate a large container.

According to an advantageous feature of the invention, the dispensing head comprises an upper stop designed to interact with the bottom of a slot formed in the front wall when the dispensing head is in the low position to prevent downward travel of the dispensing head beyond the low position.

Such a configuration makes it possible to effectively limit the downward adjustment range of the dispensing head, thus preventing it from derailing relative to the slides.

According to an advantageous feature of the invention, the third slide comprises a lower portion located underneath the first slide and second slide and an upper portion located opposite a lower part of the first slide and second slide along the transverse axis.

Such an arrangement makes it possible to ensure that even when the dispensing head is in the high position, the third slide is always in contact with the dispensing head and the latter cannot derail relative to the third slide.

According to an advantageous feature of the invention, the dispensing head comprises a first lower stop and a second lower stop designed to interact respectively with a lower end of the first slide and a lower end of the second slide when the dispensing head is in the high position to prevent upward travel of the dispensing head beyond the high position.

Such a configuration makes it possible to effectively limit the upward adjustment range of the dispensing head and thus prevent it from derailing relative to the slides. Moreover, such an arrangement makes it possible to ensure that the dispensing head conceals the third slide even when the dispensing head is in the high position.

According to an advantageous feature of the invention, the third engagement relief extends from a lower side of the dispensing head and the first and second engagement reliefs extend from an upper side of the dispensing head.

This arrangement makes it possible to ensure that an upper part of the dispensing head is held in place relative to the frame, essentially via the first and second slides, and that a lower part of the dispensing head is held in place relative to the frame, essentially via the third slide. Moreover, such an arrangement allows the dispensing head to conceal the third slide even when the dispensing head is in the high position.

According to an advantageous feature of the invention, the length of the upper portion is comprised between 2% and 20% of the length of the first slide or of the second slide.

According to an advantageous feature of the invention, each retaining component is positioned between the dispensing body and the friction member.

According to an advantageous feature of the invention, the adjustment member comprises a front panel designed to be positioned facing the front wall and in that each friction member is designed to be attached to the front panel so that it can be moved relative to the front panel along an axis perpendicular to the front wall by the retaining force applied by the retaining component to the corresponding friction member.

Such an arrangement makes it possible to guarantee optimized friction of each friction member and thus effectively hold the dispensing head in position along the longitudinal axis once this position has been set by the user.

According to an advantageous feature of the invention, each friction member comprises an upper end connected to an upper edge of the front panel and in that the front panel comprises a continuous recess along side edges and along a lower edge of the friction member.

Such an arrangement makes it possible to guarantee that each friction member can be moved relative to the front panel by the corresponding retaining component. This makes it possible to effectively hold the dispensing head in position along the longitudinal axis once the position has been set by the user, and to enable the dispensing head to move when the user manipulates the adjustment member.

According to an advantageous feature of the invention, the adjustment member comprises two friction members located on either side of a central axis of the adjustment member.

Such an arrangement makes it possible to guarantee the robustness of the machine over time, and in particular of the adjustment of the dispensing head position.

According to an advantageous feature of the invention, the adjustment member defines a housing for receiving the dispensing body and comprises two side walls extending from the front panel and designed to cooperate respectively with an outer side edge of the first slide and an outer side edge of the second slide.

Such an arrangement makes it easier to guide the dispensing head along the slides.

According to an advantageous feature of the invention, the beverage dispensing machine is a coffee machine.

### BRIEF DESCRIPTION OF THE FIGURES

The purposes, aspects and advantages of the present invention, according to the description given below of a particular embodiment of the invention presented by way of non-limiting example, will be better understood by referring to the attached drawings in which:

FIG. 1 is a perspective view of a beverage dispensing machine, in particular a coffee machine, according to one embodiment of the invention, comprising a frame and a beverage dispensing head;

FIG. 2 is a perspective view of the dispensing head and of a front panel of the frame shown in FIG. 1, with an outer casing of the frame not shown;

FIG. 3 is an exploded view of the dispensing head and of the front panel of the frame shown in FIG. 2;

FIG. 4 is a partial top view of the dispensing head and of the front panel of the frame shown in FIG. 2;

FIG. 5 is a partial rear perspective view of the dispensing head and of the front panel of the frame shown in FIG. 2;

FIG. 6 is a front perspective view of a dispensing head position adjustment member belonging to the dispensing head in FIGS. 1 to 5.

FIG. 7 is a rear perspective view of a beverage dispensing body belonging to the dispensing head in FIGS. 1 to 5.

FIG. 8 is a partial cross-sectional view along vertical section line VIII-VIII of the dispensing head and of the front panel of the frame shown in FIG. 2.

Only those elements required in order to understand the invention have been depicted. In order to facilitate interpretation of the drawings, the same elements are labeled with the same references across all the figures.

It will be noted that in this document, the terms “horizontal,” “vertical,” “lower,” “upper,” “top,” “bottom,” “front,” “rear,” “longitudinal” and “transverse” used to describe the beverage dispensing machine refer to this machine when in use, sitting flat on a countertop.

In addition, the terms “upstream” and “downstream” or “inlet” and “outlet” are defined in relation to a flow direction of the beverage in the beverage dispensing machine.

The terms “external” and “internal” as well as the terms “outer” and “inner” are defined relative to a central axis of the beverage dispensing machine. Thus, an inner portion/part will be closer to the central axis than an outer portion/part.

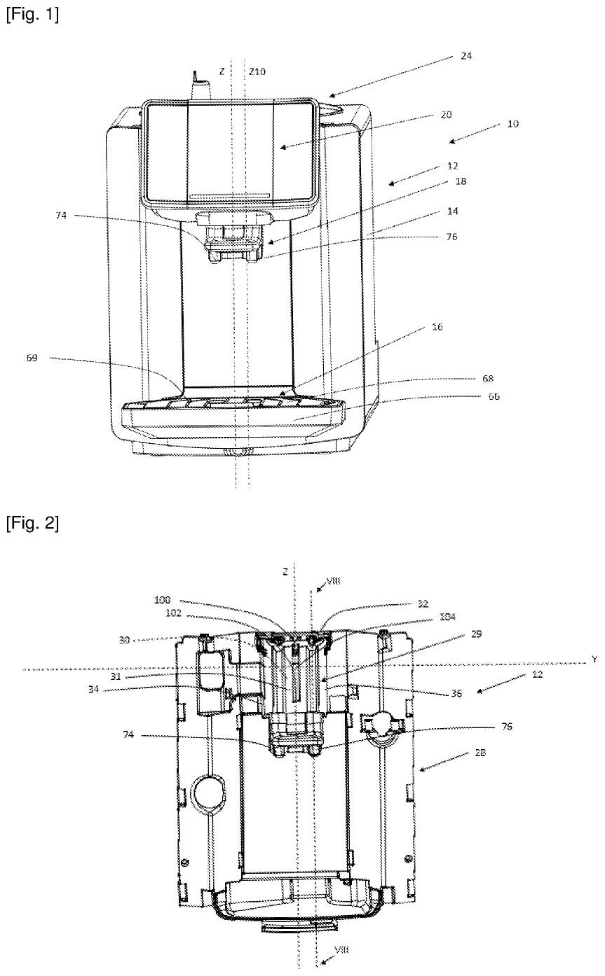

The beverage dispensing machine shown in FIG. 1 is a coffee machine 10. As a variant, the beverage dispensing machine is a filtered and/or carbonated water dispensing machine or a tea dispensing machine.

The coffee machine 10 is advantageously an automatic coffee machine.

The coffee machine 10 comprises a frame 12 equipped with an outer casing 14 and an area 16 for receiving a container or receptacle on which a container/receptacle, not shown, can be placed.

The coffee machine 10 also comprises a beverage dispensing head 18 whose position relative to the receiving area 16 along a longitudinal axis of travel Z of the dispensing head 18 can be adjusted between a high position and a low position. In the various figures, the beverage dispensing head 18 is in the high position.

The longitudinal axis Z extends in a vertical direction.

The coffee machine 10 defines a central axis Z10 running through a center of the machine and extending parallel to the longitudinal axis Z.

The coffee machine 10 advantageously comprises a human-machine interface 20 by which a user can select a type of beverage to be dispensed and, advantageously, enter settings for the coffee machine 10.

The coffee machine 10 also includes a beverage preparation unit, not shown, incorporated into the frame 12.

The preparation unit comprises a control circuit for managing the preparation of a beverage based on the instructions given by the user.

The preparation unit also comprises a boiler producing hot water and/or steam and a tank for holding cold water. The tank supplies the boiler to produce hot water and/or steam.

The preparation unit comprises a coffee bean reservoir 24, an automatic bean grinder and a brewing chamber designed to receive the ground coffee beans and to be supplied with hot water from the boiler.

The brewing chamber is fluidly connected to the dispensing head 18 such that the machine 10 is designed to dispense a beverage made with coffee.

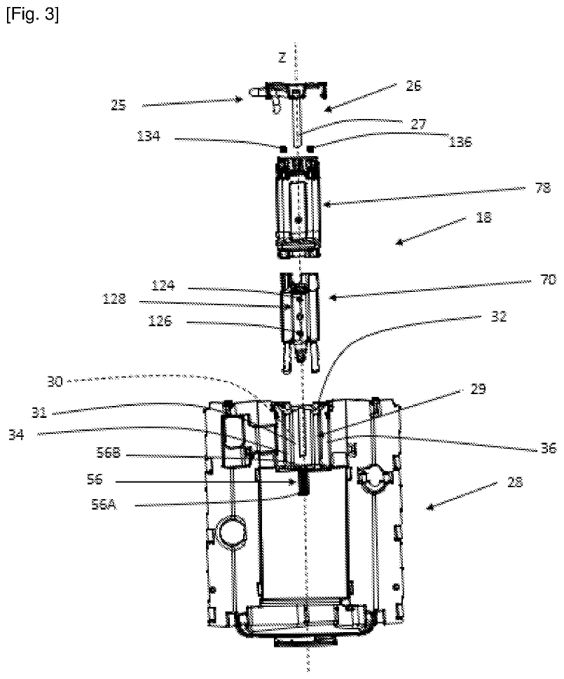

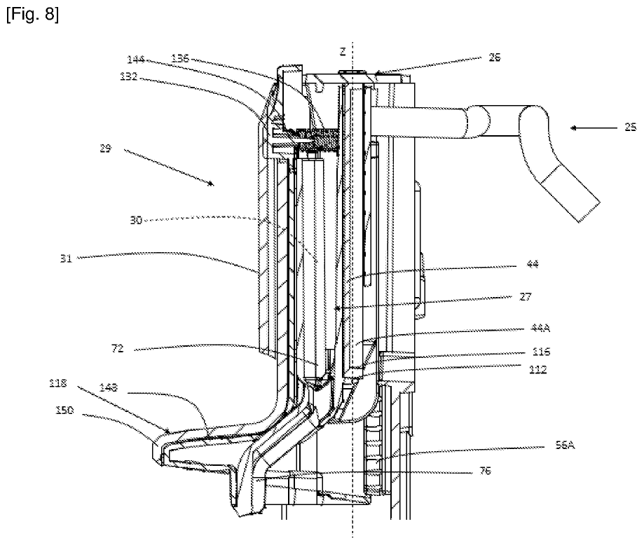

To this end, the coffee machine comprises a coffee dispensing hose 25 and a member 26 for supplying beverages to the dispensing head 18, as shown in FIGS. 3 and 8. The hose 25 fluidly connects the brewing chamber to the beverage supply member 26. The beverage supply member 26 is attached to the frame and comprises a tube 27 extending along the longitudinal axis Z and designed to deliver the beverage to the dispensing head 18.

The frame 12 defines the container receiving area 16. The frame 12 is essentially a rectangular parallelepiped.

The frame 12 comprises a front panel 28 shown in FIGS. 2 and 3, in which the outer casing 14 of the frame 12 is not shown.

The frame 12 and in particular its front panel 28 comprise a structure 29 for receiving the dispensing head 18.

The receiving structure 29 defines a space 30 for receiving the dispensing head 18. More specifically, the receiving structure 29 comprises a front wall 31, a rear wall 32 and two side walls 34, 36 delimiting the space 30 for receiving the dispensing head 18.

Advantageously, and as shown in FIG. 5, the rear wall 32 is open to facilitate the installation of the dispensing head 18 in the receiving structure 29 and to allow for the passage of the hose 25.

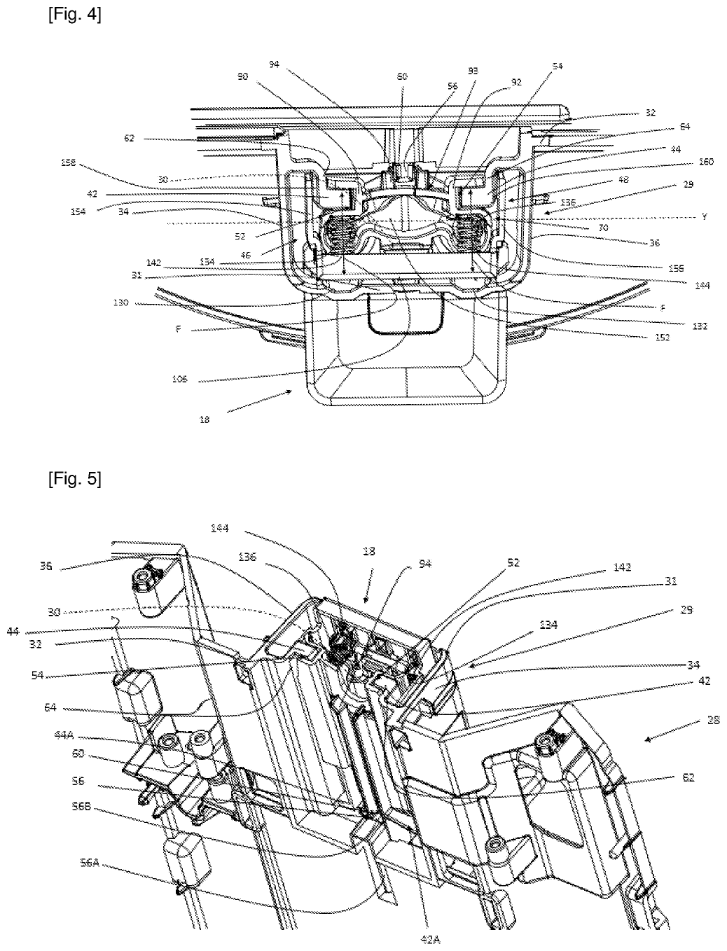

As shown in FIG. 4, the receiving structure 29 comprises a first slide 42 and a second slide 44 designed to interact with a respective lateral side 46, 48 of the dispensing head to form a first slide connection 52 and a second slide connection 54, respectively.

The receiving structure 29 also comprises a third slide, 56 positioned between the first slide 42 and the second slide 44 along a transverse axis Y substantially perpendicular to the longitudinal axis Z.

The third slide 56 is designed to interact with the dispensing head 18 to form a third slide connection 60.

The third slide 56 is closer to the receiving area 16 along the longitudinal axis Z than the first slide 42 and the second slide 44.

The first slide 42, second slide 44 and third slide 56 extend parallel to the longitudinal axis Z and comprise ribs, for example.

The first slide 42, second slide 44 and third slide 56 extend from the rear wall 32, meaning that they are attached to the rear wall 32.

More specifically, the third slide 56 extends from the rear wall perpendicular to the rear wall 32 and the first slide 42 and second slide 44 extend from the rear wall parallel to the rear wall 32.

The first slide 42 and second slide 44 are attached to the rear wall 32 by connecting links 62, 64 extending between the rear wall 32 and the corresponding slide 42, 44. Each connecting link 62, 64 comprises at least one component extending forward at right angles to the rear wall 32.

The first slide 42 and second slide 44 are located opposite each other along the transverse axis Y and extend over a similar height.

The third slide 56 is positioned equidistant from the first slide 42 and the second slide 44 along the transverse axis Y.

The third slide 56 comprises a lower portion 56A located underneath the first slide 42 and second slide 44 and an upper portion 56B located opposite a lower part 42A, 44A of the first slide and second slide along the transverse axis Y.

The length of the upper portion 56B along the longitudinal axis Z is advantageously comprised between 2% and 20% of the length of the first slide 42 or of the second slide 44.

The length of the lower portion 56A along the longitudinal axis Z is advantageously comprised between 20% and 50% of the length of the first slide 42 or of the second slide 44.

Advantageously, the length of the third slide 56 along the longitudinal axis Z is comprised between 15% and 50% of the length of the first slide 42 or of the second slide 44.

Such an arrangement of the slides 42, 44, 56 frees up the receiving area 16 to a maximum extent, in particular to accommodate a large container.

As shown in FIG. 1, the receiving area 16 is formed by a drip tray 66 on which is positioned a holder 68 designed to receive the container. The holder 68 comprises through-apertures 69 to allow the beverage collected on the holder 68 to drain off into the drip tray 66.

The beverage dispensing head 18 comprises a beverage dispensing body 70 shown in FIG. 7, defining at least one beverage flow channel 72 and advantageously provided with two beverage outlets 74, 76.

As shown in FIG. 8, the beverage outlets 74, 76 are designed to be supplied with beverage via the beverage supply member 26 and in particular the tube 27, which is designed to deliver beverage near the beverage outlets 74, 76. The beverage supply member 26 is designed to be attached to the receiving structure 29.

The beverage dispensing head 18 also comprises a member 78 for adjusting the position of the dispensing head 18 relative to the receiving area 16 along the longitudinal axis Z.

The beverage dispensing head 18 comprises:
on the first lateral side 46, a first engagement relief 90 for the first slide 42,
on the second lateral side 48, a second engagement relief 92 for the second slide 44, and
on a central part 93, a third engagement relief 94 for the third slide 56.

The first engagement relief 90 and the first slide 42 together form the first slide connection 52, while the second engagement relief 92 and the second slide 44 together form the second slide connection 54 and the third engagement relief 94 and the third slide 56 together form the third slide connection 60.

As shown in FIG. 7, the first engagement relief 90 and the second engagement relief 92 are preferably positioned on a respective lateral side 70A, 70B of the beverage dispensing body 70 and the third engagement relief 94 is preferably positioned on a central part 96 of the beverage dispensing body and in particular of a rear panel 98 of the dispensing body 70.

The first engagement relief 90, second engagement relief 92 and third engagement relief 94 are formed by grooves which preferentially have a U-shaped cross-section. The ribs forming the slides 42, 44, 56 are designed to be received in the corresponding grooves.

As a variant, the grooves are replaced by ribs and vice versa.

The third engagement relief 94 extends from a lower side 70C of the dispensing body 70, and the first engagement relief 90 and second engagement relief 92 extend from an upper side 70D of the dispensing body 70.

In other words, the third engagement relief 94 leads to the lower side 70C and the first engagement relief 90 and second engagement relief 92 lead to the upper side 70D.

The beverage dispensing body 70 thus forms a movable caddy along the slides 42, 44, 56, enabling the beverage dispensing head 18 to be displaced along the longitudinal axis Z.

Such an arrangement of the dispensing body 70 relative to the frame 12 makes it possible, via the interaction of the slides 42, 44, 56 and of the engagement reliefs 90, 92, 94, to achieve a dispensing head 18 that is easier for the user to adjust in height and whose attachment to the frame 12 is optimized.

In addition, the positioning of the third slide connection 60 makes it possible to achieve an optimized height adjustment range while ensuring effective attachment of the dispensing head 18 to the frame 12, even when the dispensing head is in the low position. This thus reduces the risk of the dispensing head 18 swiveling and/or tilting and/or derailing. As a result, the beverage dispensing machine is suited to a wider range of container heights and the user experience is enhanced.

Moreover, the relative positioning of the slides 42, 44, 56 and of the engagement reliefs 90, 92, 94 makes it possible to ensure that an upper part of the dispensing head 18 is held in place relative to the frame 12, essentially via the first and second slides 42, 44, and that a lower part of the dispensing head 18 is held in place relative to the frame 12, essentially via the third slide 56.

As shown in FIG. 2, the dispensing head 18 also comprises an upper stop 100 designed to interact with the bottom 102 of a slot 104 formed in the front wall 31 when the dispensing head 18 is in the low position to prevent downward travel of the dispensing head 18 beyond the low position.

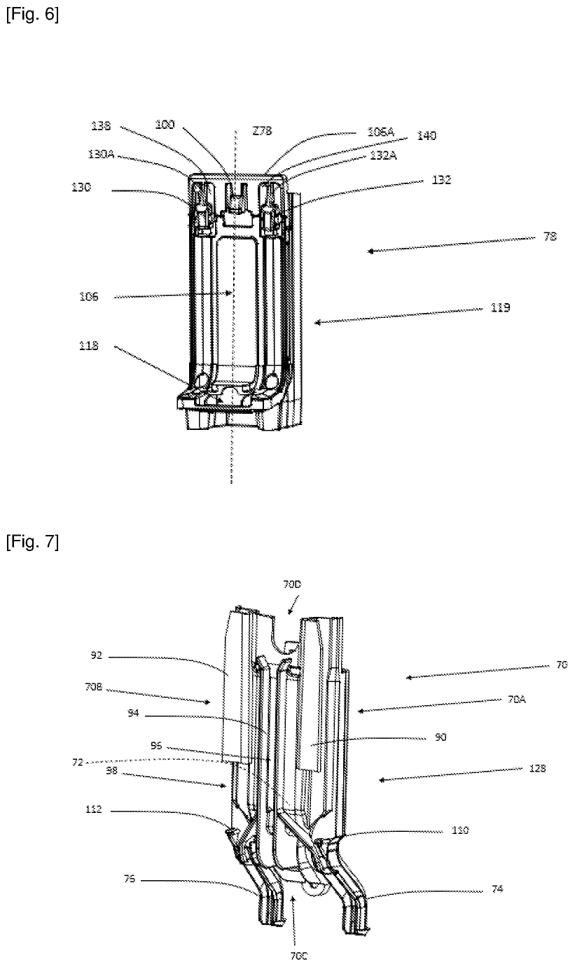

Advantageously, the upper stop 100 is formed on the adjustment member 78 and in particular on a front panel 106 of the adjustment member 78 shown in FIG. 6.

The dispensing head 18 also comprises a first lower stop 110 and a second lower stop 112 designed to interact respectively with a lower end, not shown, of the first slide 42 and a lower end 116 of the second slide 44 when the dispensing head 18 is in the high position to prevent upward travel of the dispensing head 18 beyond the high position (see FIG. 8).

As shown in FIG. 7, the lower stops 110, 112 are preferably formed on the rear panel 98 of the dispensing body 70.

Such an arrangement of the lower stops 110, 112 and of the slides 42, 44, 56 makes it possible to ensure that even when the dispensing head 18 is in the high position, the third slide 56 is always in contact with the dispensing head 18 and the latter cannot derail relative to the third slide 56.

The adjustment member 78 is shown in FIG. 6 and comprises a gripping area 118 designed to be grasped by a user to adjust the position of the dispensing head 18 between the high and low positions.

The adjustment member 78 is designed to be attached to the dispensing body 70.

In particular, the adjustment member 78 comprises, on a rear panel 119, two housings, not shown in the figures, designed to receive fastening pins 124, 126 formed on a front panel 128 of the dispensing body 70 (see FIG. 3). Each housing forms a component for attaching the adjustment member 78 to the dispensing body 70.

The adjustment member 78 comprises at least one member 130, 132 for creating friction against the front wall 31. Each friction member 130, 132 is designed to rub against a rear panel of the front wall 31.

More precisely, and as shown in the figures, the adjustment member 78 comprises two friction members 130, 132 located on either side of a central axis Z78 of the adjustment member 78 parallel to the longitudinal axis Z when the dispensing head is installed in the receiving space 30.

For each friction member 130, 132, the dispensing head 18 comprises a component 134, 136 for retaining the dispensing body 70 in position along the longitudinal axis Z.

Each retaining component 134, 136 is, for example, a spring and is designed to exert a retaining force F on the corresponding friction member 130, 132 to keep the friction member 130, 132 in contact with the front wall 31 and in particular the rear panel of the front wall 31.

Each retaining component 134, 136 is positioned between the dispensing body 70 and the corresponding friction member 130, 132. Each retaining component 134, 136 is designed to exert the corresponding retaining force F so as to keep the corresponding friction member 130, 132 in contact with the front wall 31 and the dispensing body 70 in contact with the rear wall 32 and in particular the first slide 42 or the second slide 44.

By interacting with the dispensing body 70 and the friction members 130, 132, each retaining component 134, 136 thus clamps the dispensing head 18 in the receiving structure 29 at a predetermined position along the longitudinal axis Z, once the user has stopped applying force on the gripping area 118 to move the head 18.

As shown in FIG. 6, each friction member 130, 132 is designed to be attached to the front panel 106 in such a way as to be movable relative to the front panel 106 along an axis perpendicular to the front wall 31 by the retaining force F applied by the corresponding retaining component 134, 136 to the friction member 130, 132.

More specifically, each friction member 130, 132 comprises an upper end 130A, 132A connected to an upper edge 106A of the front panel 106 and the front panel 106 comprises a continuous recess 138, 140 along side edges and along a lower edge of the friction member 130, 132.

Each friction member 130, 132 forms a pad for creating friction/braking against the rear panel of the front wall 31.

As can be seen in FIG. 5, each friction member 130, 132 also comprises an axial protrusion 142, 144 facing the rear wall 32.

Each friction member 130, 132 is positioned at an upper part of the front panel 106 and advantageously extends from the upper edge 106A of the front panel 106.

Each retaining component 134, 136 comprises a first end positioned around the corresponding axial projection 142, 144 and bearing against a rear panel of the friction member 130, 132 and a second end bearing against the dispensing body 70.

The adjustment member 78 therefore has a simplified structure and, with the help of the retaining components 134, 136, provides the user with an easy and robust means of adjusting the height of the dispensing head 18 relative to the receiving area 16 over time.

Advantageously, as shown in FIG. 8, the adjustment member 78 comprises a first monobloc part 148 forming the front panel and each friction member 130, 132 and a second monobloc part 150 designed to be attached to the first part 148 and forming a cap for the first part.

The first part 148 is preferably made of a material that is different from that of the second part 150. The second part 150 defines the contour of the user's gripping area 118 on the adjustment member.

Advantageously, as shown in FIG. 4, the adjustment member 78 defines a housing 152 for receiving the dispensing body 70 and comprises two side walls 154, 156 extending rearwards from the front panel 106, designed to cooperate respectively with an outer side edge 158 of the first slide 42 and an outer side edge 160 of the second slide 44. The front panel 106 and side walls 154, 156 define the housing 152.

Such an arrangement makes it easier to guide the dispensing head along the slides 42, 44.

Of course, the invention is in no way limited to the embodiment described and illustrated, since this embodiment was only provided by way of example. Changes can still be made, particularly with regard to the constitution of the various elements or by substituting technical equivalents, without departing from the scope of protection of the invention.

1. A beverage dispensing machine comprising:
a frame configured to receive a beverage preparation unit and defining a container receiving area; and
a beverage dispensing head whose position relative to the receiving area along a longitudinal axis of travel of the dispensing head is adjustable between a high position and a low position,
the frame comprising a dispensing head receiving structure comprising a first slide and a second slide configured to interact with a respective lateral side of the dispensing head to form a first slide connection and a second slide connection, respectively,
wherein the receiving structure further comprises a third slide, positioned between the first slide and the second slide along a transverse axis substantially perpendicular to the longitudinal axis, the third slide configured to interact with the dispensing head to form a third slide connection, the third slide being closer to the receiving area along the longitudinal axis than the first slide and the second slide.

2. The beverage dispensing machine according to claim 1, wherein the dispensing head comprises:
on a first lateral side, a first engagement relief for the first slide, the first engagement relief and the first slide forming the first slide connection,
on a second lateral side, a second engagement relief for the second slide, the second engagement relief and the second slide forming the second slide connection, and
on a central part, a third engagement relief for the third slide, the third engagement relief and the third slide forming the third slide connection.

3. The beverage dispensing machine according to claim 2; wherein the first engagement relief, second engagement relief and third engagement relief are formed by grooves having a U-shaped cross-section, and wherein the first slide, the second slide and the third slide comprise ribs configured to be received in the corresponding grooves.

4. The beverage dispensing machine according to claim 2, wherein the dispensing head further comprises a beverage dispensing body defining at least one beverage flow channel and first and second beverage outlets, the dispensing body (70) also comprising the first engagement relief (90), second engagement relief (92) and third engagement relief (94), and wherein the dispensing head comprises a member for adjusting the position of the dispensing head relative to the receiving area along the longitudinal axis, the adjustment member configured to be attached to the dispensing body and comprising a gripping area configured to be grasped by a user so that the user can adjust the position of the dispensing head between the high and low positions.

5. The beverage dispensing machine according to claim 4, wherein the receiving structure comprises a front wall and a rear wall delimiting a space for receiving the dispensing head, wherein the adjustment member comprises at least one member for creating friction against the front wall and for each friction member the dispensing head comprises a retaining component for retaining the dispensing body in position along the longitudinal axis, each retaining component being configured to exert a retaining force on the corresponding friction member to keep the friction member in contact with the front wall.

6. The beverage dispensing machine according to claim 1, wherein the receiving structure comprises a front wall and a rear wall delimiting a space for receiving the dispensing head, the first slide, the second slide and the third slide extending from the rear wall.

7. The beverage dispensing machine according to claim 6, wherein the third slide extends perpendicularly to the rear wall and wherein the first slide and second slide extend parallel to the rear wall.

8. The beverage dispensing machine according to claim 5, wherein the dispensing head comprises an upper stop configured to interact with a bottom of a slot formed in the front wall when the dispensing head is in the low position to prevent downward travel of the dispensing head beyond the low position.

9. The beverage dispensing machine according to claim 1, wherein the third slide comprises a lower portion located underneath the first slide and the second slide, and an upper portion facing a lower part of the first and the second slides along the transverse axis (Y).

10. The beverage dispensing machine according to claim 1, wherein the dispensing head comprises a first lower stop and a second lower stop configured to interact respectively with a lower end of the first slide and a lower end of the second slide when the dispensing head is in the high position to prevent upward travel of the dispensing head beyond the high position.
